(19) United States
(12) Patent Application Publication
(10) Pub. No.: US 2024/0077650 A1
(43) Pub. Date: Mar. 7, 2024

(54) TWO-WAY OPTICAL PATH SYSTEM, OPTICAL ASSEMBLY, AND OPTICAL APPARATUS

(71) Applicant: Shphotonics Ltd, Suzhou (CN)

(72) Inventors: Shanfeng QIU, Suzhou (CN); Lei SUN, Suzhou (CN)

(21) Appl. No.: 18/357,516

(22) Filed: Jul. 24, 2023

(30) Foreign Application Priority Data
Sep. 1, 2022 (CN) 202211067885.8

(51) Int. Cl. G02B 1/00

(52) U.S. Cl. CPC G02B 1/002

(57) ABSTRACT

A two-way optical path system includes a metasurface lens. The metasurface lens is configured to deflect first incident light incident on a first surface of the metasurface lens as first outgoing light and second incident light incident on a second surface of the metasurface lens as second outgoing light. The first outgoing light and the second outgoing light are received by a first image sensor and a second image sensor for imaging, respectively, or the first incident light and the second incident light are from a first light emitter and a second light emitter, respectively.

### CROSS-REFERENCE TO RELATED APPLICATION

This application claims priority to Chinese Application No. 202211067885.8, filed on Sep. 1, 2022, the entire content of which is incorporated herein by reference.

### TECHNICAL FIELD

The present disclosure relates to the optical imaging technology field and, in particular, to a two-way optical system, an optical assembly, and an optical apparatus.

### BACKGROUND

In existing technology, two cameras with opposite photographing directions are configured in a monitoring scene to realize two-way photography. Because two cameras are used, the apparatus cost is high, and the apparatus occupies a relatively large space.

In another existing technology, a gimbal camera is configured in the monitoring scene. Photographing with 360° field of view is realized by controlling the rotation of the camera through a gimbal. Since the camera photographs at only one angle at a certain moment, this is not real time monitoring of the entire field of view. Moreover, the cost of the gimbal is high, and the gimbal camera occupies a relatively large space.

### SUMMARY

Embodiments of the present disclosure provide a two-way optical path system including a metasurface lens. The metasurface lens is configured to deflect first incident light incident on a first surface of the metasurface lens as first outgoing light and second incident light incident on a second surface of the metasurface lens as second outgoing light. The first outgoing light and the second outgoing light are received by a first image sensor and a second image sensor for imaging, respectively, or the first incident light and the second incident light are from a first light emitter and a second light emitter, respectively.

Embodiments of the present disclosure provide an optical assembly, including a housing and a two-way optical path system. The housing includes a plurality of light-passing windows. The two-way optical path system is arranged in the housing and includes a metasurface lens. The metasurface lens is configured to deflect first incident light incident on a first surface of the metasurface lens as first outgoing light and second incident light incident on a second surface of the metasurface lens as second outgoing light. The first outgoing light and the second outgoing light are received by a first image sensor and a second image sensor for imaging, respectively, or the first incident light and the second incident light are from a first light emitter and a second light emitter, respectively.

Embodiments of the present disclosure provide an optical apparatus including an optical assembly. The optical assembly includes a housing and a two-way optical path system. The housing includes a plurality of light-passing windows. The two-way optical path system is arranged in the housing. The two-way optical path system includes a metasurface lens. The metasurface lens is configured to deflect first incident light incident on a first surface of the metasurface lens as first outgoing light and second incident light incident on a second surface of the metasurface lens as second outgoing light. The first outgoing light and the second outgoing light are received by a first image sensor and a second image sensor for imaging, respectively, or the first incident light and the second incident light are from a first light emitter and a second light emitter, respectively.

### BRIEF DESCRIPTION OF THE DRAWINGS

FIG. 1 is a schematic diagram of a two-way optical system according to some embodiments of the present disclosure.

FIG. 2 is a schematic diagram of a two-way optical system according to some embodiments of the present disclosure.

FIG. 3A is a schematic cross-sectional diagram of a metasurface lens of a two-way optical system according to some embodiments of the present disclosure.

FIG. 3B is a schematic cross-sectional diagram of a metasurface lens of a two-way optical system according to some embodiments of the present disclosure.

FIG. 3C is a schematic cross-sectional diagram of a metasurface lens of a two-way optical system according to some embodiments of the present disclosure.

FIG. 4A is a schematic diagram of an optical assembly according to some embodiments of the present disclosure.

FIG. 4B is a schematic diagram of an optical assembly according to some embodiments of the present disclosure.

FIG. 5 is a schematic diagram of an optical assembly according to some embodiments of the present disclosure.

FIG. 6 is a schematic diagram of an optical assembly according to some embodiments of the present disclosure.

FIG. 7 is a schematic diagram of an optical assembly according to some embodiments of the present disclosure.

FIG. 8 is a schematic diagram of an optical assembly according to some embodiments of the present disclosure.

FIG. 9 is a schematic diagram of an optical assembly according to some embodiments of the present disclosure.

FIG. 10 is a schematic diagram of an optical assembly according to some embodiments of the present disclosure.

FIG. 11 is a schematic diagram showing connection of two optical assemblies included in an optical apparatus according to some embodiments of the present disclosure.

FIG. 12 is a schematic diagram of a two-way optical system according to some embodiments of the present disclosure.

### DETAILED DESCRIPTION OF THE EMBODIMENTS

In the following, some example embodiments are described. As those skilled in the art would recognize, the described embodiments can be modified in various manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers. In this disclosure, if a light beam encounters a first element and then reaches a second element, the second element is referred to as being downstream the first element or downstream the first element in an optical path, and correspondingly the first element is referred to as being upstream the second element or upstream the second element in the optical path.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

In related technology, to realize a larger field of view for monitoring, two cameras facing opposite directions can be used, or a gimbal can be used to control the rotation of a camera. Although the two cameras facing opposite directions can be configured to realize two-way photography, the cost can be high, and the two cameras can occupy a relatively large space. The camera with the gimbal cannot monitor an entire field of view in real time. The gimbal can be expensive and occupy a relatively large space. In addition, the inventors of the present disclosure also know that conventional lenses have significant chromatic aberration. Thus, two-way control of light can be difficult to realize using the conventional lenses, and clear imaging in both directions cannot be realized.

Embodiments of the present disclosure provide a two-way optical path system, an optical assembly, and an optical apparatus. Thus, the optical apparatus can realize a two-way optical path function, the cost of the optical apparatus can be lowered, and space occupied by the optical apparatus can be reduced.

In embodiments of the present disclosure, the two-way optical path system can include a metasurface lens. The metasurface lens can be configured in such a way that first incident light incident on a first surface is deflected by the metasurface lens as first outgoing light and second incident light incident on a second surface is deflected by the metasurface lens as second outgoing light. A first imaging sensor and a second imaging sensor can be configured to receive the first outgoing light and the second outgoing light, respectively, and generate images. In some other embodiments, the first incident light and the second incident light can be emitted from a first light emitter and a second light emitter, respectively.

In some embodiments, the two-way optical path system can include a first image sensor and a second image sensor. The first outgoing light and the second outgoing light can be received by the first image sensor and the second image sensor, respectively, for imaging. Thus, the two-way optical path system can be a two-way imaging system. The two-way imaging system can be applied to an imaging apparatus such as a two-way monitoring camera, a panoramic camera, and a spherical camera.

In some embodiments, the two-way optical path system can include the first light emitter and the second light emitter. The first incident light and the second incident light can be emitted from the first light emitter and the second light emitter, respectively. Thus, the two-way optical path system can be a two-way light emission system. The two-way light emission system can be cooperatively used with the imaging apparatus or applied to an integrated light supplement apparatus or a lighting apparatus.

Based on the two-way control design of the metasurface lens, the optical apparatus including the above two-way optical path system can be at least configured to realize the two-way optical path function. The two-way optical paths may not interfere with each other. Thus, the optical apparatus can at least realize the two-way optical path function, the cost of the optical apparatus can be lowered, and the space occupied by the optical apparatus can be reduced. For example, compared to the two cameras facing opposite directions or the camera controlled by the gimbal, the cost of the imaging apparatus can be effectively reduced, and the space occupied by the imaging apparatus can be reduced by using the two-way imaging system of embodiments of the present disclosure. For example, compared to using two light supplement apparatuses with opposite light emitting directions, the cost can be saved, and the space occupied by the apparatus can be reduced by using the two-way emission system of embodiments of the present disclosure.

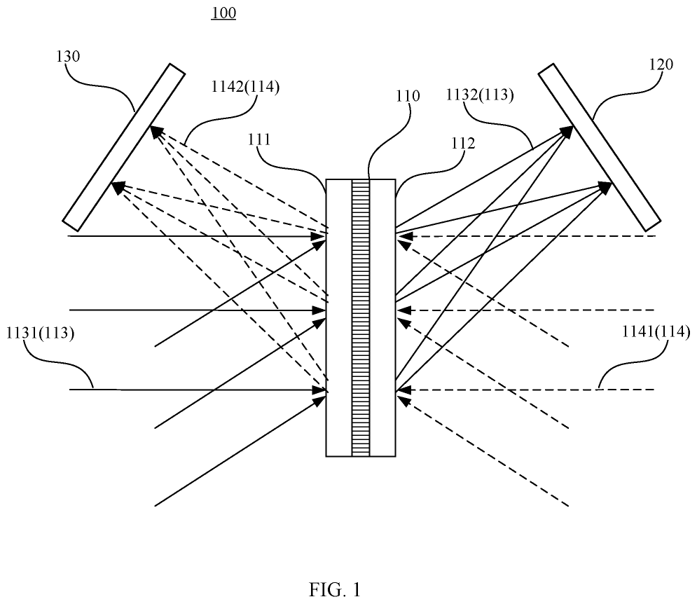

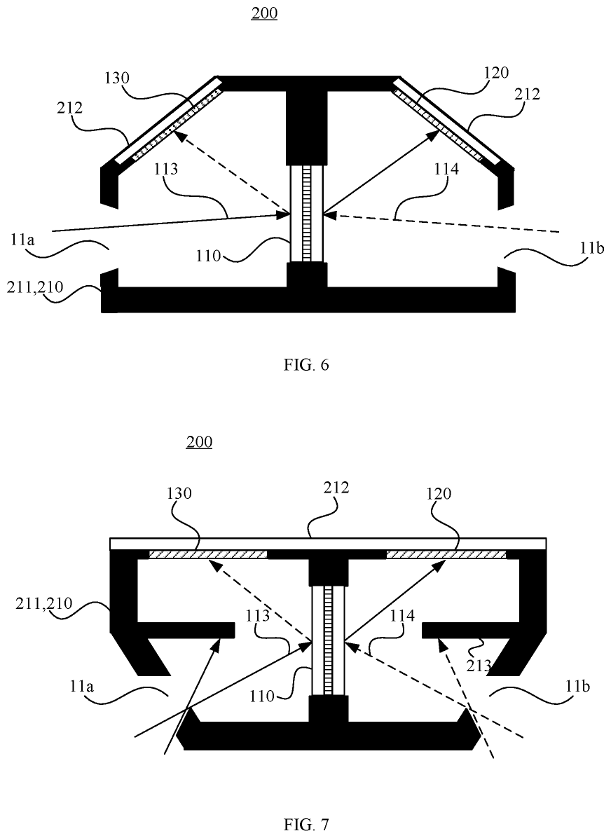

Embodiments of the present disclosure are further described in detail by taking a two-way optical path system 100 as the two-way imaging system as an example in connection with FIG. 1 to FIG. 11. Correspondingly, an optical assembly 200 included in the two-way optical path system 100 can be an imaging module, and an optical apparatus included in the two-way optical path system 100 can be an imaging apparatus.

As shown in FIG. 1, the two-way optical path system 100 of embodiments of the present disclosure includes a first image sensor 120, a second image sensor 130, and a lens system. The lens system includes a metasurface lens 110. The metasurface lens includes a first surface 111 and a second surface 112 facing each other. The metasurface lens 110 can be configured to deflect first incident light 1131 incident on the first surface 111 as first outgoing light 1132 to be received by the first image sensor 120 for imaging and deflect the second incident light 1141 incident on the second surface 112 as second outgoing light 1142 to be received by the second image sensor 130 for imaging.

Image sensor is an apparatus that can convert an optical image into an electronic signal and is widely used in electronic optical apparatuses such as digital camera. In embodiments of the present disclosure, the image sensor can be a complementary metal-oxide-semiconductor (CMOS) image sensor or a charge-coupled device (CCD) image sensor, which is not limited here.

Metasurface refers to an artificial two-dimensional material. A basic structure unit of metasurface is a nanostructure unit with a size in an order of nanometers and smaller than a working wavelength. Metasurface can realize flexible and effective control of the characteristics, such as propagation direction, polarization mode, amplitude, and phase, of electromagnetic waves. Metasurface can also have an ultra-light characteristic. A metasurface optical apparatus made based on the metasurface device can have good optical performance, small volume, and high integration compared to a conventional optical apparatus. A metalens can be an optical apparatus based on the metasurface technology in a plane shape.

In embodiments of the present disclosure, the metasurface lens 110 can have two-way control over incident light from two sides. Thus, the first surface 111 of the metasurface lens 110 used as a first optical path 113 of an incident light surface and the second surface 112 of the metasurface lens 110 used as a second optical path 114 of an incident light surface can form images on the first image sensor 120 and the second image sensor 130, respectively. The two imaging optical paths can share the same metasurface lens 110.

Although the lens system shown in FIG. 1 only includes the metasurface lens 110, in some other embodiments of the present disclosure, the lens system can include other optical apparatuses, such as a curved lens or an aperture, optically coupled to the metasurface lens 110.

In the two-way optical path system 100 of embodiments of the present disclosure, based on the two-way control of the metasurface lens 110, the first image sensor 120 and the second image sensor 130 can simultaneously receive light from two directions of two sides. Thus, the optical apparatus including the two-way optical path system 100 can at least realize a two-way photography function, which can be performed in real-time. Compared to the two cameras facing opposite directions or the camera controlled by the gimbal, with the two-way optical path system 100 of embodiments of the present disclosure, the cost of the optical apparatus can be lowered, and the space occupied by the optical apparatus can be reduced.

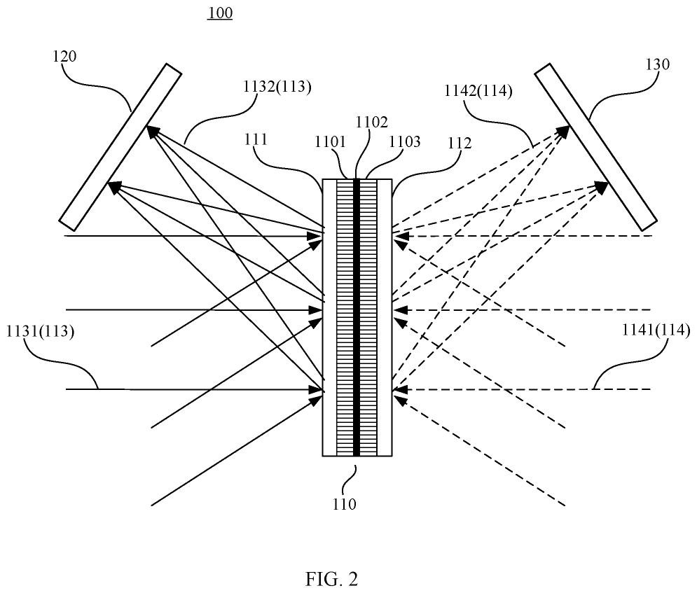

As shown in FIG. 1, in some embodiments of the present disclosure, the metasurface lens 110 is configured in a manner that the first outgoing light 1132 and the second outgoing light 1142 are both transmitted light. As shown in FIG. 2, in other embodiments of the present disclosure, the metasurface lens 110 is configured in a manner that the first outgoing light 1132 and the second outgoing light 1142 are both reflected light. The two-way optical path system 100 of embodiments of the present disclosure can realize the two-way photography function.

In embodiments of the present disclosure, specific positions and relative positions of the first image sensor 120 and the second image sensor 130 are limited. The specific positions of the first image sensor 120 and the second image sensor 130 can be flexibly arranged based on a specific structure and internal space of the optical assembly 200 of the optical apparatus.

In some embodiments, the first image sensor 120 and the second image sensor 130 are symmetrically arranged on two sides of the metasurface lens 110, which simplifies the structural design and optical design of the optical assembly 200 and facilitates manufacturing.

In other embodiments, according to actual design requirements, the first image sensor 120 and the second image sensor 130 can also be asymmetrically arranged on the two sides of the metasurface lens 110.

In some embodiments, an incident surface of the first image sensor 120 and an incident surface of the second image sensor 130 can have an angle therebetween.

In other embodiments, the incident surface of the first image sensor 120 and the incident surface of the second image sensor 130 can also be parallel to each other.

In yet other embodiments, the incident surface of the first image sensor 120 and the incident surface of the second image sensor 130 can also be in a same plane.

In embodiments of the present disclosure, specific types and specifications of the first image sensor 120 and the second image sensor 130 are not limited and may be identical or different.

In embodiments of the present disclosure, the specific structure of the metasurface lens 110, a specific material used in each layer, and a specific fabrication process are not limited, as long as the metasurface lens 110 can realize the two-way control over the incident light from the two sides.

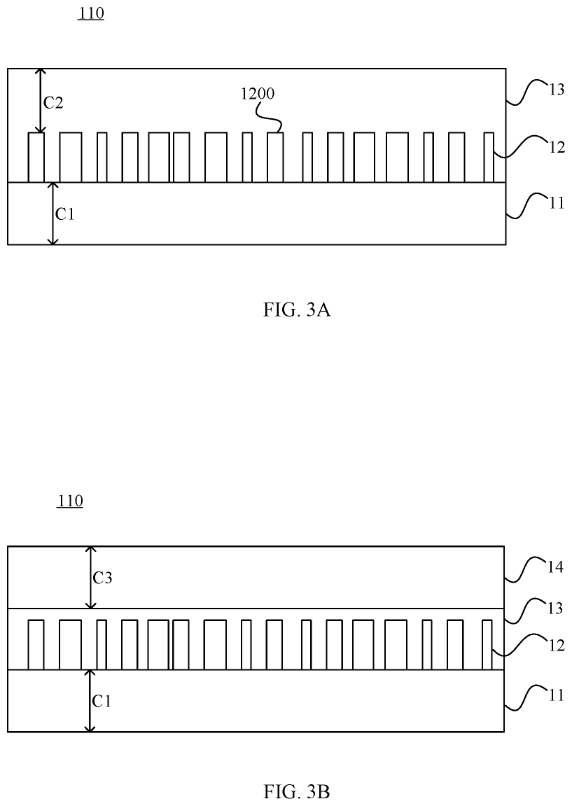

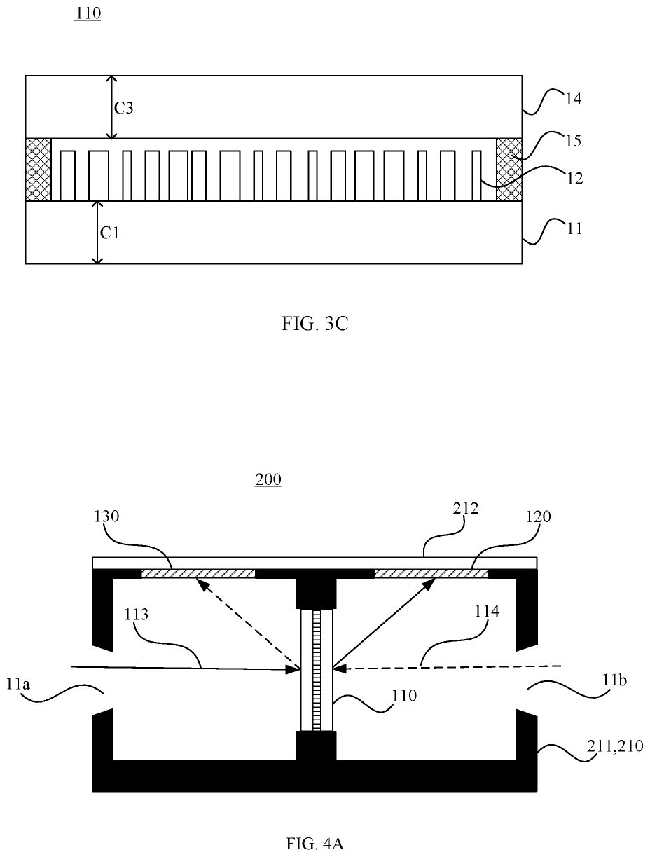

As shown in FIG. 3A, in some embodiments of the present disclosure, the first outgoing light 1132 and the second outgoing light 1142 are transmitted light. The metasurface lens 110 includes a substrate 11, a nanostructure layer 12, and a cover layer 13 that are stacked one over another.

A material type of the substrate 11 is not limited and may include any one or a combination of glass, quartz, polymers, and plastics. The nanostructure layer 12 includes a plurality of nanostructure units 1200 spaced apart from each other. A material of the nanostructure layer 12 is not limited and may include at least one of single-crystal silicon, polycrystalline silicon, amorphous silicon, silicon carbide, titanium dioxide, silicon nitride, hafnium oxide, germanium, or III-V compound semiconductor. The III-V compound refers to a compound formed by the elements boron, aluminum, gallium, and indium from Group III and nitrogen, phosphorus, arsenic, and antimony from Group V of the periodic table, for example, gallium phosphide, gallium nitride, gallium arsenide, indium phosphide, etc.

In embodiments of the present disclosure, the nanoscale structure units 1200 of the nanoscale structure layer 12 can be nanocolumn units or nanoaperture units (FIG. 3A shows the nanocolumn units). A shape of a nanocolumn unit or a nanoaperture unit is not limited and include a cylindrical shape, a square-column shape, a rectangular-column shape, a concentric-cylindrical shape, a star-column shape, etc. The metasurface lens 110 can realize the two-way control over the light based on a design of parameters of the nanostructure unit 1200, such as shape, size, height, periodicity, arrangement, and material, and design of other structure layers (e.g., substrate 11 and cover layer 13).

In embodiments of the present disclosure, the substrate 11 and the cover layer 13 can have a same refractive index, a same material, and a same thickness. In some other embodiments, at least one of the refractive index, the material, and the thickness of the substrate 11 and the cover layer 13 can be different. In some embodiments, the cover layer 13 with the same refractive index as the substrate 11 can be formed on the nanoscale structure layer 12 through a spin coating process. The cover layer 13 can be made of an organic or inorganic material, which can be the same as or different from the material of the substrate 11. Thickness C2 of the cover layer 12 can be the same as thickness C1 of the substrate 11. Thus, the metasurface lens 110 can realize the two-way control over the light.

In some embodiments, the cover layer 13 can be formed on the nanostructure layer 12 through a physical vapor deposition or a chemical vapor deposition. Thickness C2 of the cover layer 13 can be the same as thickness C1 of the substrate 11. The cover layer 13 and the substrate 11 can be made of the same material. Thus, the metasurface lens 110 can realize the two-way control over the light.

In other embodiments, based on an optical adjustment design of the nanostructure layer 12, thickness C2 of the cover layer 13 can be different from thickness C1 of the substrate 11. For example, thickness C2 of the cover layer 13 can be smaller than or greater than thickness C1 of the substrate 11.

As shown in FIG. 3B, in some embodiments of the present disclosure, the first outgoing light 1132 and the second outgoing light 1142 are transmitted light. The metasurface lens 110 includes the substrate 11, the nanostructure layer 12, the cover layer 13, and a bonding wafer layer 14 stacked one over another. The refractive indexes, materials, and thicknesses of the substrate 11 and the bonding wafer layer 14 can be the same or different.

For example, a layer of a wafer that have the same material and thickness as the substrate 11 can be bonded on the cover layer 13 through a wafer bonding process to form the bonding wafer layer 14. Thus, the metasurface lens 110 can realize the two-way control over the light.

In some embodiments, thickness C3 of the bonding wafer layer 14 can be the same as thickness C1 of the substrate 11. In other embodiments of the present disclosure, with the optical adjustment function of the nanostructure layer 12, thickness C3 of the bonding wafer layer 14 can be different from thickness C1 of the substrate 11 without affecting the two-way imaging of the two-way optical path system 100.

As shown in FIG. 3C, in some embodiments of the present disclosure, the first outgoing light 1132 and the second outgoing light 1142 are transmitted light. The metasurface lens 110 includes the substrate 11, the nanostructure layer 12, and the bonding wafer layer 14 stacked one over another and a support 15 arranged between the substrate 11 and the bonding wafer layer 14 and around the nanostructure layer 12. The refractive indexes, materials, and thicknesses of the substrate 11 and the bonding wafer layer 14 can be the same or different.

For example, a layer of wafer that has the same material and thickness as the substrate 11 can be bonded to the support 15 through a wafer bonding process to form the bonding wafer layer 14. Thus, the metasurface lens 110 can realize two-way control over light.

In some embodiments, thickness C3 of the bonding wafer layer 14 can be the same as thickness C1 of the substrate 11. In other embodiments, with the optical control function of the nanostructure layer 12, the bonding wafer layer 14 can also be made of a material different from the material of the substrate 11, or have a different thickness, without affecting the two-way imaging of the two-way optical path system 100.

The structure of the metasurface lens 110 is not limited to the above designs. The metasurface lens 110 can also include other functional layers such as an anti-reflection layer, a filter layer, a polarization layer, etc., which are not illustrated in the drawings.

As shown in FIG. 2, in some embodiments of the present disclosure, the metasurface lens 110 is configured in a manner that the first outgoing light 1132 and the second outgoing light 1142 are reflected light. The metasurface lens 110 includes a first nanoscale structure layer 1101, a reflection layer 1102, and a second nanoscale structure layer 1103 that are sequentially arranged. The two side surfaces of the reflection layer 1102 can be configured to reflect light. The reflected light can be adjusted by the first nanostructure layer 1101 and the second nanostructure layer 1103, respectively. Then, the reflected light can be emitted from the metasurface lens 110.

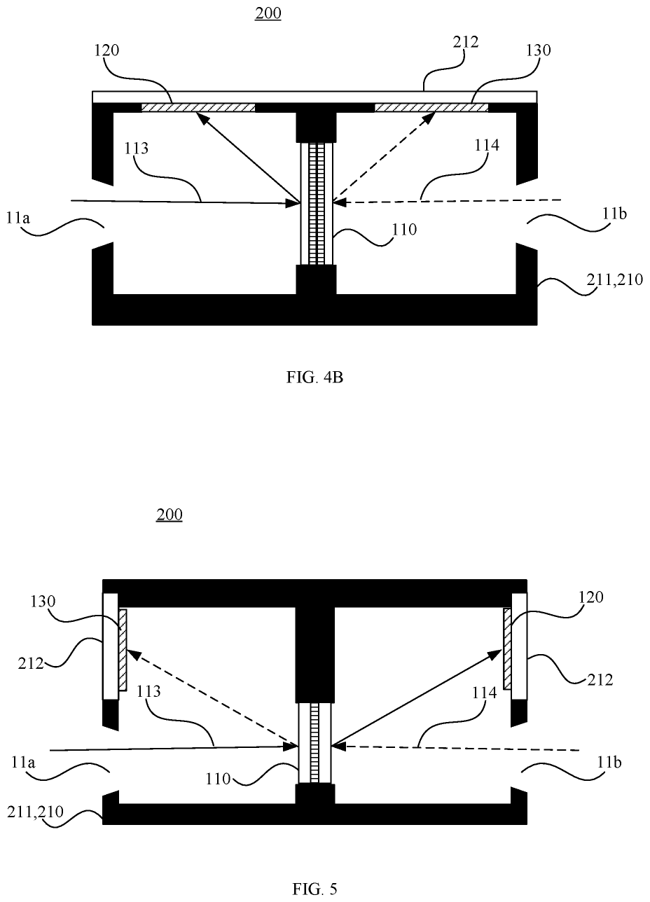

As shown in FIGS. 4A and 4B, embodiments of the present disclosure also provide an optical assembly 200. The optical assembly 200 includes a housing 210 with a plurality of light-passing windows (e.g., a first light-passing window 11a and a second light-passing window 11b) and at least one two-way optical path system 100 above.

Based on the design of the two-way optical path system of embodiments of the present disclosure, the optical assembly 200 can at least realize the two-way photography function. In addition, the apparatus with the optical assembly 200 can have a relatively low cost and occupy a relatively small space.

The optical assembly 200 includes one or more two-way optical path systems 100 above. When one two-way optical path system is included, two-way photography can be realized. When two two-way optical path systems are included, 360° panoramic photography can be realized through an appropriate arrangement. The light-passing window can be configured to allow external light to enter the housing 210 and be received by the image sensor after being controlled by the metasurface lens 110.

As shown in FIGS. 4A, 4B, and 5 to 7, in some embodiments, the optical assembly 200 includes one two-way optical path system 100 above. The plurality of light-passing windows include the first light-passing window 11a and the second light-passing window 11b that are in one-to-one correspondence with the first surface and the second surface of the metasurface lens 110. The first light-passing window 11a can be configured to allow the incident light incident on the first surface of the metasurface lens 110 to pass through the first light-passing window 11a. The second light-passing window 11b can be configured to allow the incident light incident on the second surface of the metasurface lens 110 to pass through the second light-passing window 11b. For example, the first light-passing window 11a and the second light-passing window 11b can face the first surface and the second surface of the metasurface lens 110 in one-to-one correspondence.

As shown in FIGS. 4A, 4B, 5, and 6, in some embodiments, the first light-passing window 11a and the second light-passing window 11b are parallel to each other. As shown in FIG. 7, in some embodiments, the first light-passing window 11a and the second light-passing window 11b have an angle therebetween. The optical assembly 200 of embodiments of the present disclosure not only can realize the two-way photography function but also has a relatively small volume and relatively low manufacturing cost compared to the related technology.

As shown in FIG. 4B, in some other embodiments of the present disclosure, the two-way optical path system is a reflective two-way optical path system employing the metasurface lens 110. That is, based on the structural design of the metasurface lens 110, the first optical path 113 and the second optical path 114 can be reflection optical paths.

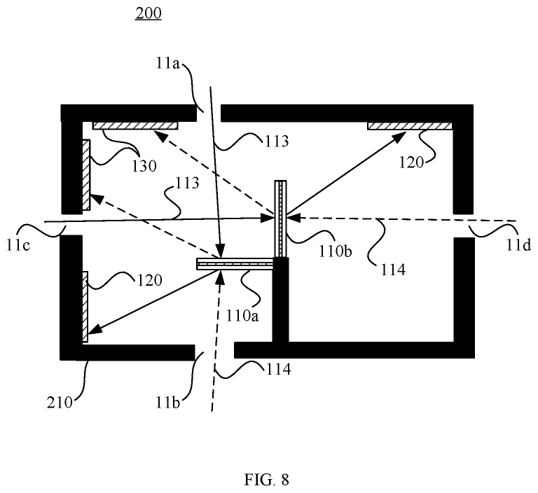

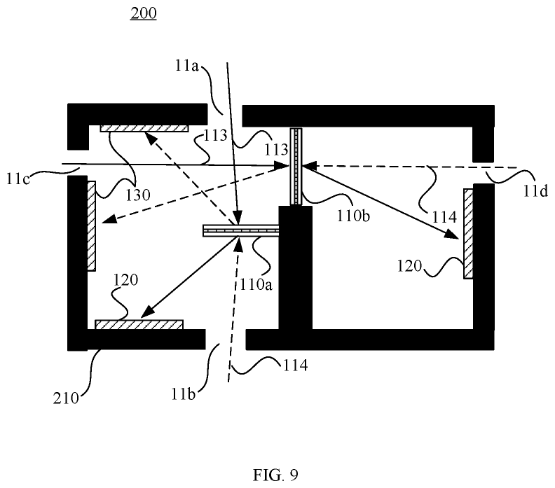

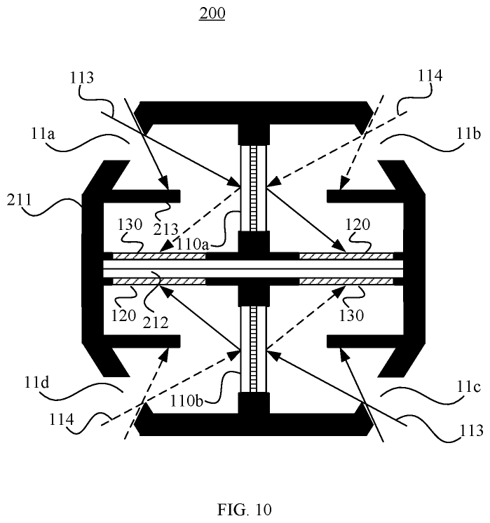

As shown in FIGS. 8 and 9, in some embodiments, the optical assembly 200 includes two two-way optical path systems 100, i.e., a first two-way optical path system and a second two-way optical path system. A metasurface lens 110a of the first two-way optical path system and a metasurface lens 110b of the second two-way optical path system are arranged orthogonal to each other. The plurality of light-passing windows include the first light-passing window 11a and the second light-passing window 11b arranged in the one-to-one correspondence with the first surface and the second surface of the metasurface lens 110a the first two-way optical path system and s third light-passing window 11c and a fourth light-passing window 11d arranged in the one-to-one correspondence with the first surface and the second surface of the metasurface lens 110b of the second two-way optical path system. The first light-passing window 11a can be configured to allow the incident light incident on the first surface of the metasurface lens 110a of the first two-way optical path system to pass through the first light-passing window 11a. The second light-passing window 11b can be configured to allow the incident light incident on the second surface of the metasurface lens 110a of the first two-way optical path system to pass through the second light-passing window 11b. For example, the first light-passing window 11a and the second light-passing window 11b can face the first surface and the second surface of the metasurface lens 110a in the one-to-one correspondence. Moreover, in some embodiments, the first light-passing window 11a and the second light-passing window 11b can be parallel to the metasurface lens 110a of the first two-way optical path system. The third light-passing window 11c can be configured to allow the incident light incident on the first surface of the metasurface lens 110b of the second two-way optical path system, and the fourth light-passing window 11d can be configured to allow the incident light incident on the second surface of the metasurface lens 110b of the second two-way optical path system. For example, the third light-passing window 11c and the fourth light-passing window 11d can face the first surface and the second surface of the metasurface lens 110b in the one-to-one correspondence. In addition, in some embodiments, the third light-passing window 11c and the fourth light-passing window 11d can be parallel to the metasurface lens 110b of the second two-way optical path system. The optical assembly 200 of embodiments of the present disclosure can realize 360° panoramic photography and have a relatively small volume and relatively low manufacturing cost.

As shown in FIG. 10, in some embodiments, the optical assembly 200 includes two two-way optical path systems 100, i.e., the first two-way optical path system and the second two-way optical path system. The metasurface lens 110a and the metasurface lens 110b of the two two-way optical path systems are arranged side by side in a tiled manner. The plurality of light-passing windows include the first light-passing window 11a and the second light-passing window 11b in the one-to-one correspondence with the first surface and the second surface of the metasurface lens 110a of the first two-way optical path system and the third light-passing window 11c and the fourth light-passing window 11d in the one-to-one correspondence with the first surface and the second surface of the metasurface lens 110b of the second two-way optical path system. The first light-passing window 11a can be configured to allow the incident light incident on the first surface of the metasurface lens 110a of the first two-way optical path system to pass through the first light-passing window 11a. The second light-passing window 11b can be configured to allow the incident light incident on the second surface of the metasurface lens 110a of the first two-way optical path system to pass through the second light-passing window 11b. For example, the first light-passing window 11a and the second light-passing window 11b face in the one-to-one correspondence with the first surface and the second surface of the metasurface lens 110a, and the first light-passing window 11a and the second light-passing window 11b can have an angle therebetween. The third light-passing window 11c can be configured to allow incident light incident on the first surface of the metasurface lens 110b of the second two-way optical path system to pass through the third light-passing window 11c. The fourth light-passing window 11d can be configured to allow incident light incident on the second surface of the metasurface lens 110b of the second two-way optical path system to pass through the third light-passing window 11d. For example, the third light-passing window 11c and the fourth light-passing window 11d face the first surface and the second surface of the metasurface lens 110b in the one-to-one correspondence, and the third light-passing window 11c and the fourth light-passing window 11d can have an angle therebetween. The optical assembly 200 can realize 360° panoramic photography and have a relatively small volume and relatively low manufacturing cost.

In some embodiments of the present disclosure, the optical assembly can include three two-way optical path systems, i.e., a first two-way optical path system, a second two-way optical path system, and a third two-way optical path system. A metasurface lens of the first two-way optical path system can be orthogonally arranged with a metasurface lens of the second two-way optical path system, and the metasurface lens of the second two-way optical path system can be orthogonally arranged with a metasurface lens of the third two-way optical path system. A plurality of light-passing windows can include a first light-passing window and a second light-passing window arranged in one-to-one correspondence with the first surface and the second surface of the metasurface lens of the first two-way optical path system (for example, face the first surface and the second surface of the metasurface lens of the first two-way optical path system in one-to-one correspondence), a third light-passing window and a fourth light-passing window arranged in one-to-one correspondence with the first surface and the second surface of the metasurface lens of the second two-way optical path system (for example, face the first surface and the second surface of the metasurface lens of the second two-way optical path system in one-to-one correspondence), and a fifth light-passing window and a sixth light-passing window arranged in one-to-one correspondence with the first surface and the second surface of the metasurface lens of the third two-way optical path system (for example, face the first surface and the second surface of the metasurface lens of the third two-way optical path system in one-to-one correspondence). The first light-passing window can be configured to allow incident light incident on the first surface of the metasurface lens of the first two-way optical path system to pass through the first light-passing window. The second light-passing window can be configured to allow incident light incident on the second surface of the metasurface lens of the first two-way optical path system to pass through the second light-passing window. The first light-passing window and the second light-passing window can be parallel to the metasurface lens of the first two-way optical path system. The third light-passing window can be configured to allow incident light incident on the first surface of the metasurface lens of the second two-way optical path system to pass through the third light-passing window. The fourth light-passing window can be configured to allow incident light incident on the second surface of the metasurface lens of the second two-way optical path system to pass through the fourth light-passing window. The third light-passing window and the fourth light-passing window can be parallel to the metasurface lens of the second two-way optical path system. The fifth light-passing window can be configured to allow incident light incident on the first surface of the metasurface lens of the third two-way optical path system to pass through the fifth light-passing window. The sixth light-passing window can be configured to allow incident light incident on the second surface of the metasurface lens of the third two-way optical path system to pass through the sixth light-passing window. The fifth light-passing window and the sixth light-passing window can be parallel to the metasurface lens of the third two-way optical path system. The optical assembly of embodiments of the present disclosure can realize panoramic photography without a dead angle in space.

In the optical assembly 200 of embodiments of the present disclosure, a transmissive two-way optical path system with the metasurface lens can be used. That is, based on the structural design of the metasurface lens, the first optical path 113 and the second optical path 114 can be transmission optical paths.

In some other embodiments of the present disclosure, the optical assembly 200 can also employ a reflective two-way optical path system having the metasurface lens. That is, based on the structural design of the metasurface lens, the first optical path 113 and the second optical path 114 can be reflection optical paths, which are not illustrated in the drawings.

As shown in FIGS. 4A, 4B, 5, 6, 7, and 10, in some embodiments of the present disclosure, the housing 210 includes a main body 211 and at least one substrate 212 connected to the main body 211. The first image sensor 120 and the second image sensor 130 of the two-way optical path system can be prepared on the at least one substrate 212. The image sensors can be prepared on the substrate 212 and then can be mounted to the main body 211, which can improve the mounting accuracy of the image sensors to improve the imaging quality.

As shown in FIGS. 7 and 10, in some embodiments, a shading member 213 configured to block stray light is designed inside the housing 210 corresponding to each light-passing window. The shading member 213 can include a protrusion structure or a plate structure and can be integrally formed with the main body 211 through injection molding. The shading member 213 can be configured to block the stray light entering the optical assembly 200, which improves the signal-to-noise ratio of the two-way optical path system to improve the imaging quality.

Embodiments of the present disclosure further provide an optical apparatus. The optical apparatus can include the optical assembly 200 above. The optical apparatus can at least be configured to realize the two-way photography function. Compared to the related technology, the cost can be low, and the occupied space can be small. A specific type of optical apparatus is not limited. For example, the optical apparatus can include a two-way monitoring camera, a panoramic camera, a spherical camera, etc. According to different types of optical apparatuses, two-way photography, 360° panoramic photography, or panoramic photography in space without a dead angle can be realized.

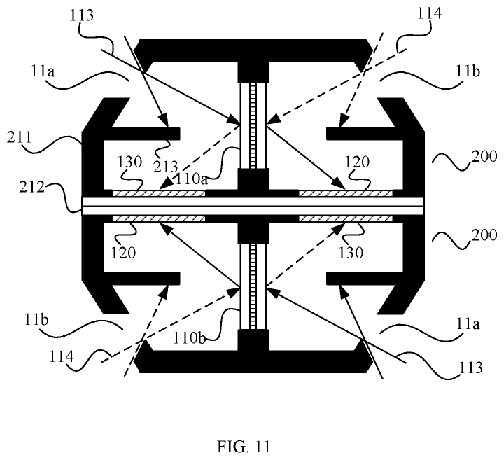

Referring to FIG. 11, in some embodiments, the optical apparatus includes two optical assemblies 200 connected back-to-back. Each optical assembly 200 includes the two-way optical path system. The metasurface lens 110a and the metasurface lens 110b of the two-way optical path systems of the two optical assemblies 200 are arranged side by side in a tiled manner. Each optical assembly 200 includes the first light-passing window 11a and the second light-passing window 11b arranged in one-to-one correspondence with the first surface and the second surface of the metasurface lens 110. The first light-passing window 11a and the second light-passing window 11b have an angle therebetween.

The two optical assemblies 200 shown in FIG. 7 can be fixed together in any manner, such as an adhesive bonding manner, a snap manner, or a fastening manner. Thus, the optical apparatus can realize 360° panoramic photography.

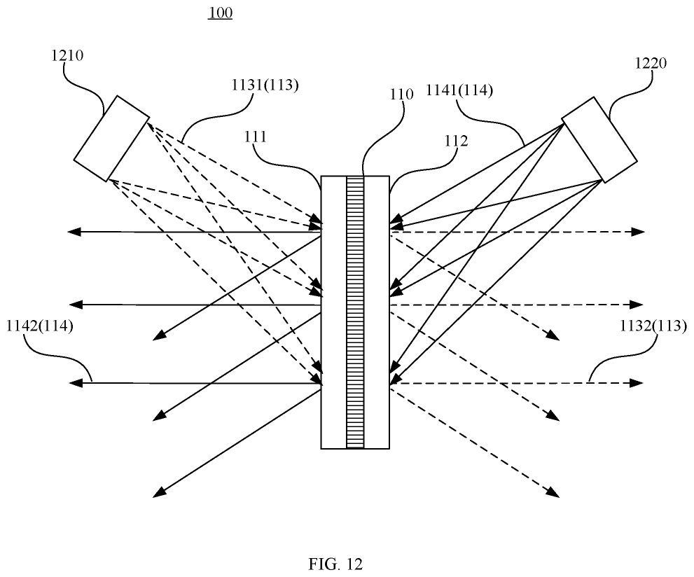

As shown in FIG. 12, in some embodiments of the present disclosure, the two-way optical path system 100 is a two-way light emission system. The two-way optical path system 100 includes a first light emitter 1210, a second light emitter 1220, and a lens system. The lens system includes a metasurface lens 110. The metasurface lens 110 includes a first surface 111 and a second surface 112 facing each other. The metasurface lens 110 can be configured to deflect the first incident light 1131 from the first light emitter 1210 incident on the first surface 111 as first outgoing light 1132, which can be emitted from a side of the metasurface lens 110. The metasurface lens 110 can be further configured to deflect the second incident light 1141 from the second light emitter 1220 incident on the second surface 112 as the second outgoing light 1142, which can be emitted from another side of the metasurface lens 110.

Compared to the two-way imaging system, the optical path of the two-way emission system can be reversed theoretically. The two-way emission system can include the optical assembly and the optical apparatus of the two-way light emission system, which are not described in detail. The corresponding design can be performed according to embodiments of the present disclosure.

Compared to the two light supplement apparatuses with opposite light emission directions, the apparatus cost can be saved, and the space occupied by the apparatus can be reduced using the two-way light emission system.

The present disclosure provides many different embodiments or examples used to implement the present disclosure. The different embodiments or examples are exemplary and are not used to limit the scope of the present disclosure. Those skilled in the art can think of various changes or replacements based on the disclosed contents of the present disclosure. These changes or replacements are within the scope of the present disclosure. Thus, the scope of the present invention is subject to the scope of the appended claims.

What is claimed is:

1. A two-way optical path system comprising:
a metasurface lens configured to deflect first incident light incident on a first surface of the metasurface lens as first outgoing light and second incident light incident on a second surface of the metasurface lens as second outgoing light, wherein:
the first outgoing light and the second outgoing light are received by a first image sensor and a second image sensor for imaging, respectively; or
the first incident light and the second incident light are from a first light emitter and a second light emitter, respectively.

2. The system according to claim 1, wherein:
the first outgoing light and the second outgoing light are transmitted light; and
the metasurface lens includes a substrate, a nanostructure layer, and a cover layer stacked one over another, wherein refractive indexes, materials, and thicknesses of the substrate and the cover layer are same.

3. The system according to claim 1, wherein:
the first outgoing light and the second outgoing light are transmitted light; and
the metasurface lens includes a substrate, a nanostructure layer, and a cover layer stacked one over another, wherein the cover layer differs from the substrate in at least one of refractive index, material, or thickness.

4. The system according to claim 1, wherein:
the first outgoing light and the second outgoing light are transmitted light; and
the metasurface lens includes a substrate, a nanostructure layer, a cover layer, and a bonding wafer layer stacked one over another, and a support formed between the substrate and the bonding wafer layer and around the nanostructure layer, wherein refractive indexes, materials, and thicknesses of the substrate and the bonding wafer layer are same.

5. The system according to claim 1, wherein:
the first outgoing light and the second outgoing light are transmitted light; and
the metasurface lens includes a substrate, a nanostructure layer, a cover layer, and a bonding wafer layer stacked one over another, and a support formed between the substrate and the bonding wafer layer and around the nanostructure layer, wherein the bonding wafer differs from the substrate in at least one of refractive index, material, or thickness.

6. The system according to claim 1, wherein:
the first outgoing light and the second outgoing light are transmitted light; and
the metasurface lens includes a substrate, a nanostructure layer, and a bonding wafer layer stacked one over another, and a support formed between the substrate and the bonding wafer layer and around the nanostructure layer, wherein refractive indexes, materials, and thicknesses of the substrate and the bonding wafer layer are same.

7. The system according to claim 1, wherein:
the first outgoing light and the second outgoing light are transmitted light; and
the metasurface lens includes a substrate, a nanostructure layer, and a bonding wafer layer stacked one over another, and a support formed between the substrate and the bonding wafer layer and around the nanostructure layer, wherein the bonding wafer differs from the substrate in at least one of refractive index, material, or thickness.

8. The system according to claim 1, wherein:
the first outgoing light and the second outgoing light are reflected light; and
the metasurface lens includes a first nanostructure layer, a reflection layer, and a second nanostructure layer that are arranged in sequence.

9. The system according to claim 1, wherein:
the two-way optical path system includes the first image sensor and the second image sensor, and an angle not equaling 180° exists between an incident surface of the first image sensor and an incident surface of the second image sensor; or
the two-way optical path system includes the first light emitter and the second light emitter, and an angle not equaling 180° exists between an emission surface of the first light emitter and an emission surface of the second light emitter.

10. The system according to claim 1, wherein:
the two-way optical path system includes the first image sensor and the second image sensor, and an incident surface of the first image sensor and an incident surface of the second image sensor are parallel to each other or are arranged on a same plane; or
the two-way optical path system includes the first light emitter and the second light emitter, and an emission surface of the first light emitter and an emission surface of the second light emitter are parallel to each other or are arranged on a same plane.

11. The system according to claim 1, wherein
the two-way optical path system includes the first image sensor and the second image sensor, and the first image sensor and the second image sensor are symmetrically arranged on two sides of the metasurface lens; or
the two-way optical path system includes the first light emitter and the second light emitter, and the first light emitter and the second light emitter are symmetrically arranged on two sides of the metasurface lens.

12. An optical assembly comprising:
a housing including a plurality of light-passing windows; and
a two-way optical path system arranged in the housing and including:
a metasurface lens configured to deflect first incident light incident on a first surface of the metasurface lens as first outgoing light and second incident light incident on a second surface of the metasurface lens as second outgoing light, wherein:
the first outgoing light and the second outgoing light are received by a first image sensor and a second image sensor for imaging, respectively; or
the first incident light and the second incident light are from a first light emitter and a second light emitter, respectively.

13. The optical assembly according to claim 12, wherein:
the plurality of light-passing windows include a first light-passing window and a second light-passing window facing the first surface and the second surface of the metasurface lens in a one-to-one correspondence, wherein the first light-passing window and the second light-passing window are arranged in parallel to each other.

14. The optical assembly according to claim 12, wherein:
the plurality of light-passing windows include a first light-passing window and a second light-passing window facing the first surface and the second surface of the metasurface lens in a one-to-one correspondence, wherein an angle not equaling 180° exists between the first light-passing window and the second light-passing window.

15. The optical assembly according to claim 12,
wherein the two-way optical path system is a first two-way optical path system;
the optical assembly further comprising:
a second two-way optical path system arranged in the housing;
wherein:
the metasurface lens of the first two-way optical path system and the metasurface lens of the second two-way optical path system are arranged orthogonal to each other; and
the light-passing windows include:
a first light-passing window and a second light-passing window facing the first surface and the second surface of the metasurface lens of the first two-way optical path system in a one-to-one correspondence, wherein the first light-passing window and the second light-passing window are parallel to the metasurface lens of the first two-way optical path system; and
a third light-passing window and a fourth light-passing window facing the first surface and the second surface of the metasurface lens of the second two-way optical path system in a one-to-one correspondence, wherein the third light-passing window and the fourth light-passing window are parallel to the metasurface lens of the second two-way optical path system.

16. The optical assembly according to claim 12,
wherein the two-way optical path system is a first two-way optical system;
the optical assembly further comprising:
a second two-way optical path system arranged in the housing;
wherein:
the metasurface lens of the first two-way optical path system and the metasurface lens of the second two-way optical path system are arranged side by side in a tiled manner; and
the light-passing windows include:
a first light-passing window and a second light-passing window facing the first surface and the second surface of the metasurface lens of the first two-way optical path system in a one-to-one correspondence, wherein the first light-passing window and the second light-passing window have an angle therebetween; and
a third light-passing window and a fourth light-passing window facing the first surface and the second surface of the metasurface lens of the second two-way optical path system in a one-to-one correspondence, wherein the third light-passing window and the fourth light-passing window have an angle therebetween.

17. The optical assembly according to claim 8,
wherein the two-way optical path system is a first two-way optical path system;
the optical assembly further comprising:
a second two-way optical path system and a third two-way optical path system arranged in the housing;
wherein:
the metasurface lens of the first two-way optical path system and the metasurface lens of the second two-way optical path system are arranged orthogonal to each other, and the metasurface lens of the second two-way optical path system and the metasurface lens of the third two-way optical path system are arranged orthogonal to each other; and
the light-passing windows include:
a first light-passing window and a second light-passing window facing the first surface and the second surface of the metasurface lens of the first two-way optical path system in a one-to-one correspondence, wherein the first light-passing window and the second light-passing window are parallel to the metasurface lens of the first two-way optical path system;
a third light-passing window and a fourth light-passing window facing the first surface and the second surface of the metasurface lens of the second two-way optical path system in a one-to-one correspondence, wherein the third light-passing window and the fourth light-passing window are parallel to the metasurface lens of the second two-way optical path system; and
a fifth light-passing window and a sixth light-passing window facing the first surface and the second surface of the metasurface lens of the third two-way optical path system in a one-to-one correspondence, wherein the fifth light-passing window and the sixth light-passing window are parallel to the metasurface lens of the third two-way optical path system.

18. The optical assembly according to claim 12, further comprising:
a shading member arranged in the housing and corresponding to at least one of the plurality of light-passing windows to block stray light.

19. An optical apparatus comprising an optical assembly including:
a housing including a plurality of light-passing windows; and
a two-way optical path system arranged in the housing and including:
a metasurface lens configured to deflect first incident light incident on a first surface of the metasurface lens as first outgoing light and second incident light incident on a second surface of the metasurface lens as second outgoing light, wherein:
the first outgoing light and the second outgoing light are received by a first image sensor and a second image sensor for imaging, respectively; or
the first incident light and the second incident light are from a first light emitter and a second light emitter, respectively.
